(19) United States
(12) Patent Application Publication
(10) Pub. No.: US 2012/0133118 A1
(43) Pub. Date: May 31, 2012

(54) Self-adhesive Notepaper Holder

(76) Inventor: David C.T. Jour, Taipei (TW)

(21) Appl. No.: 12/955,696

(22) Filed: Nov. 29, 2010

(51) Int. Cl. B42D 9/00

(52) U.S. Cl. 281/42

(57) ABSTRACT

A self-adhesive notepaper holder comprising: a paging plate, which is of an elongated shape with a through-hole close to the short side; the short side is folded and extended to form a holder; several notches of different shapes are set at a long side of said paging plate; and multiple self-adhesive membrane sets, each of which is partially bonded by several layers of self-adhesive transparent fluorescent membrane, and then bonded and arranged onto the paging plate to cover the notch; the membrane is available with fluorescent colors, such as: red, orange, yellow, green and blue; in the applications, the lingers may press the through-hole to prop the holder open, and then fasten it freely onto the inner sheet of portable loose-leaf notebook (or organizer and other books, etc) as a bookmark, meanwhile multiple self-adhesive membrane sets can be accessed at any time.

### BACKGROUND OF INVENTION

1. Field of the Invention

The present invention relates generally to a self-adhesive notepaper holder, and more particularly to an innovative one which can be freely incorporated onto inner sheet of loose-leaf notebook (or organizer and other books, etc) as a temporary bookmark, allowing to access freely the attached self-adhesive membrane for marking or labeling with high flexibility and convenience.

2. Description of Related Art

Self-adhesive notepaper is a most commonly-used product in recent years, which allows a special gum to be applied at one side of small plain paper; as the gum of proper viscosity can be easily torn down from the surface without any residual, the people can apply such self-adhesive notepaper to easily convey short messages to other interested parties for a timely response. With the universal education and improvement of knowledge, self-adhesive notepaper is widely used in various industries to record real-time important matters, making post-it-note an indispensable article in everyday life.

As for a common notepaper structure, multiple pieces of notepaper are superimposed into the holder, and then the upper notepaper can be firstly torn down from the preset opening of the holder; a proper amount of gum is applied between notepaper in the same direction for easy bonding and positioning; since the self-adhesive notepaper is extremely thin, the entire notepaper may be disengaged from the holder, leading to difficulty of use.

Secondly, the notepaper holder of certain space and weight is suitable for desktop applications due to poorer portability.

Thirdly, the profitability and competitiveness of notepaper cannot be improved greatly due to lack of change in overall structure and appearance.

Furthermore, a highlighter of different colors is also used to note important information similar to notepaper, but restricted. much for marking on important files having specific functions or made of certain materials, especially when extensive marking or coloring on the same file makes it difficult for reading.

Thus, to overcome the aforementioned. problems of the prior art, it would be an advancement if the art to provide an improved structure that can significantly improve the efficacy.

Therefore, the inventor has provided the present invention of practicability after deliberate design and evaluation based on years of experience in the production, development and design of related products.

### CONTENT OF INVENTION

The primary objective of the present invention is to provide a self-adhesive notepaper holder, which can be quickly and freely incorporated onto inner sheet of portable loose-leaf notebook (or organizer and other books, etc), allowing to use it as a temporary bookmark and also access it flexibly and easily.

Another objective of the present invention is to provide a self-adhesive notepaper holder, which can be used flexibly and conveniently to improve the project value and market competitiveness.

Another objective of the present invention is to provide a novel notepaper holder that can be used to improve the decorative and visual effect in lieu of the transparent fluorescent membrane of the conventional highlighter.

The self-adhesive notepaper holder comprises:

a paging plate, which is of an elongated shape with a through-hole close to the short side; the short side is folded and extended to form a holder; moreover, several notches of different shapes are set on either long side of the paging plate; and

multiple self-adhesive membrane sets, each of which is partially bonded by several layers of self-adhesive transparent fluorescent membrane, and then bonded and arranged at interval onto the paging plate.

In the actual applications, the users may, where necessary, use it directly or as a temporary bookmark in combination with inner sheet of the loose-leaf notebook (or organizer and other books, etc), thus realizing higher portability and convenience.

Several notches are set at a long side of said paging plate; and the notch is of any geometrical shape.

Said multiple self-adhesive membrane sets are of any geometrical shape.

Said multiple self-adhesive membrane sets are available with fluorescent colors of different brightness.

The features and advantages of the present invention will be more readily understood upon a thoughtful deliberation of the following detailed description of a preferred embodiment of the present invention with reference to the accompanying drawings:

### SUMMARY OF THE INVENTION

Referring to FIG. 1—an innovative “self-adhesive notepaper holder” of the present invention, which comprises:

a paging plate 1, which is a thin plate of any geometrical shape; in the preferred embodiment, it refers to a rectangular thin plate with arched corners; a through-hole 11 is properly set on the paging plate 1 close to short side, and configured in a round shape or other geometrical shapes; the short side is folded and extended to form a holder 12; when it is incorporated onto the inner sheet of the loose-leaf notebook (or organizer and other books, etc), the holder 12 can be quickly and smoothly gripped. and fastened; multiple notches 13 of different shapes are set on either long side of the paging plate 1, as shown in FIG. 3;

Multiple self-adhesive membrane sets 2, each of which comprises of several self-adhesive transparent fluorescent membranes superimposed and then bonded partially; the self-adhesive membrane sets 2 are of any geometrical shape available with fluorescent colors of different brightness, such as: red, orange, yellow, green and blue; moreover, letters or signs can be imprinted on the surface of every self-adhesive transparent fluorescent membrane for easy identification and marking or highlighting; in the practice, the self-adhesive transparent fluorescent membrane can be directly adhered onto important files or books to be marked without drawing lines, while avoiding scribbling in lieu of highlighter and maintaining original appearance of important files or books.

Additionally, a larger dimension of said. paging plate 1 means more self-adhesive membrane sets 2 of various shapes can be incorporated for flexible use and longer service time.

Referring to FIG. 2, said multiple self-adhesive membrane sets 2 are arranged towards a long side of the paging plate, and incorporated. onto the paging plate 1 by partial bonding, and a spacing is kept between self-adhesive membrane sets 2 to avoid interference by nearby ones and ensure easy access; one end of every self-adhesive membrane set 2 is flushed with the long side of the paging plate 1 to cover the notch 13, enabling the users to take out the membrane one by one; in addition, the self-adhesive membrane sets 2 are available with different fluorescence colors, and arched sides and corners are set in tune with the dark-colored. paging plate 1 to form an integrated and innovative self-adhesive notepaper holder with good visual effect.

With this construction, said self-adhesive notepaper holder can be used for marking and labeling, where necessary, or carried by the users in tune with the shape of loose-leaf notebook (or organizer and other books, etc); referring to FIG. 4, the fingers may pass through the through-hole 11 of the paging plate 1 to prop the holder 12 open, such that the paging plate 1 and holder 12 can be gripped securely on the inner sheet of the loose-leaf notebook (or organizer and other books, etc); in such case, the entire self-adhesive notepaper holder can be used as a bookmark, which is placed onto the inner sheet or taken off from the inner sheet easily.

Referring to FIG. 5, when the self-adhesive notepaper holder is already incorporated with the inner sheet of loose-leaf notebook (or organizer and other books, etc) and made ready for use, either of self-adhesive membrane sets 2 can be selected and. taken out individually depending on the preferable colors and demands of the users, thus making it possible for real-lime convenient marking and labeling.

Given its transparency, said self-adhesive transparent fluorescent membrane can be directly attached to the letters on files or books requiring for marking purpose in lieu of the highlighter. This could maintain the data integrity of original files or books while preventing any possible scribbling, thus helping to tear off easily the self-adhesive transparent fluorescent membrane and maintain original appearance of files or books.

As the present invention is an innovative product not yet publicly available complying with the spirit of new patents, the patent claims are made hereto.

However, the above-specified is only a description of preferred embodiments of the present invention, and the equivalent structural changes of the operating instructions and schematic views hereto shall be covered within the scope of the patent.

### BRIEF DESCRIPTION OF THE DRAWINGS

FIG. 1: an exploded view of the preferred embodiment of the self-adhesive notepaper holder of the present invention.

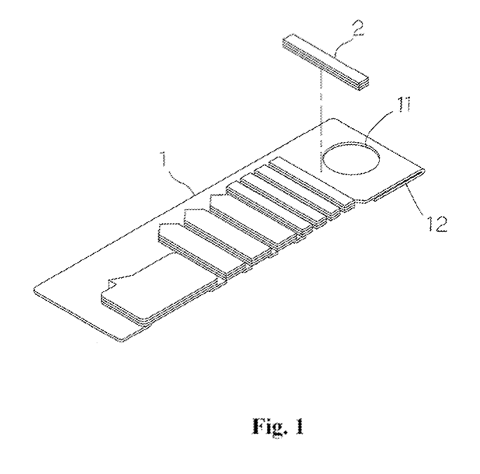

FIG. 2: an assembled view of the preferred embodiment of the self-adhesive notepaper holder the present invention.

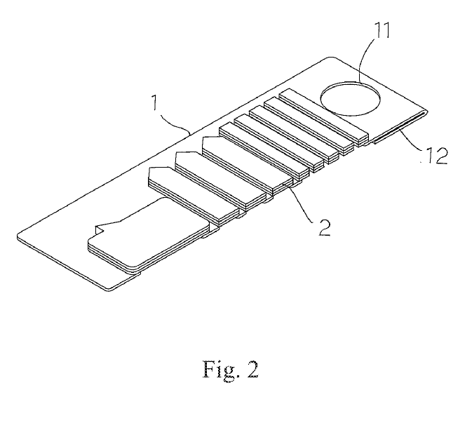

FIG. 3: a bottom view of the preferred embodiment of the self-adhesive notepaper holder the present invention.

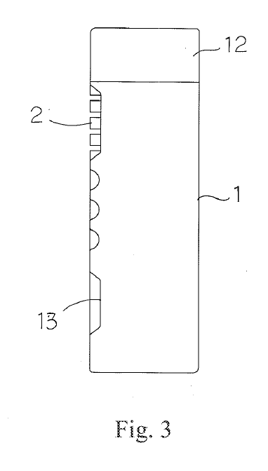

FIG. 4: an actuating view of the preferred embodiment of the self-adhesive notepaper holder the present invention.

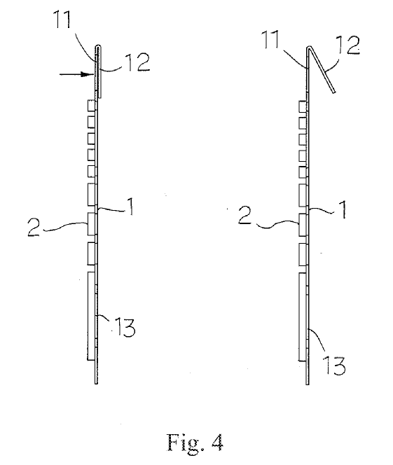

FIG. 5: an operating view of the preferred embodiment of the self-adhesive notepaper holder the present invention.

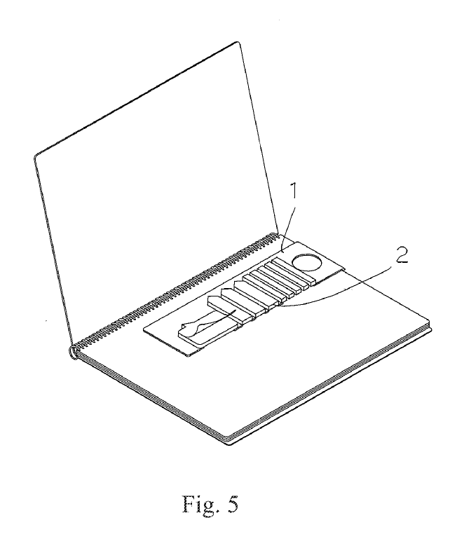

FIG. 6: another operating view of the preferred embodiment of the self-adhesive notepaper holder the present invention.

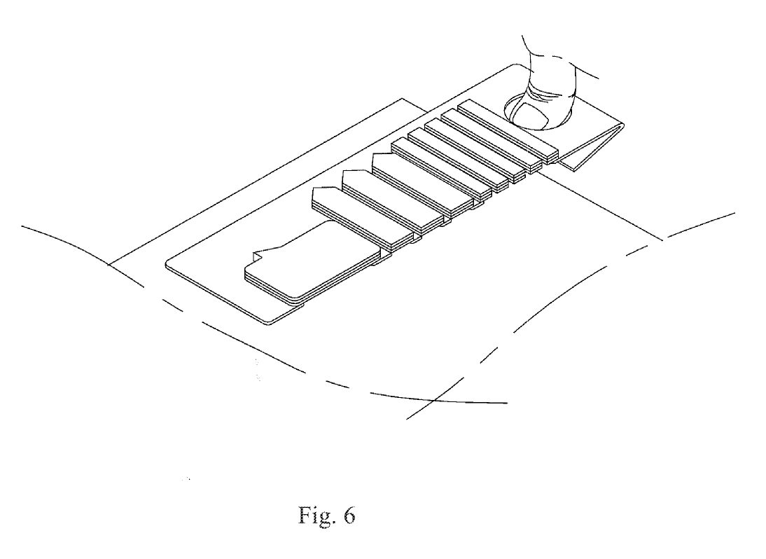

1. A self-adhesive notepaper holder, comprising:
a paging plate, which is of an elongated shape with a through-hole close to the short side; the short side is folded and extended to form a holder; multiple self-adhesive membrane sets, each of which is partially bonded by several layers of self-adhesive transparent fluorescent membrane, and then bonded and arranged onto the paging plate.

2. The structure defined in claim 1, wherein several notches of different shapes are set at a long side of said paging plate, and one end of all self-adhesive membrane sets is covered onto the notch.

3. The structure defined in claim 1, wherein said multiple self-adhesive membrane sets are of any geometrical shape.

4. The structure defined in claim 1, wherein said multiple self-adhesive membrane sets are available with fluorescent colors of different brightness.

5. The structure defined in claim 2, wherein said notch is of any geometrical shape.
